(19) United States
(12) Patent Application Publication
(10) Pub. No.: US 2016/0205575 A1
(43) Pub. Date: Jul. 14, 2016

(54) METHOD FOR MAKING QUALITY MEASUREMENT REPORT BY TERMINAL AND TERMINAL USING SAME

(71) Applicant: LG ELECTRONICS INC., Seoul (KR)

(72) Inventors: Sunghoon JUNG, Seoul (KR); Youngdae LEE, Seoul (KR)

(21) Appl. No.: 14/911,874

(22) PCT Filed: Aug. 18, 2014
(86) PCT No.: PCT/KR2014/007611

§ 371 Date: Feb. 12, 2016

Related U.S. Application Data
(60) Provisional application No. 61/866,511, filed on Aug. 15, 2013.

(51) Int. Cl. H04W 24/10; H04W 24/02

(52) U.S. Cl. CPC H04W 24/10; H04W 24/02

(57) ABSTRACT

Provided are a method for making a quality measurement report by a terminal in which a plurality of serving cells in the same frequency band are configured, and a terminal using the method. The method comprises the steps of: receiving measurement configuration information; performing quality measurements on some or all of the plurality of serving cells according to the measurement configuration information; determining whether a measurement report criterion is met on the basis of a result of the quality measurement; and transmitting a report message including the result of the quality measurement when the measurement report criterion is met, wherein the measurement configuration information contains reference information, and the reference information indicates a reference cell by which it is determined whether the measurement report criterion is met.

### BACKGROUND OF THE INVENTION

1. Field of the Invention

The present invention relates to a method of performing a quality measurement report of a user equipment (UE) in a mobile communication system, and a UE apparatus for the method.

2. Related Art

It is necessary for a mobile communication system to support a mobility of a user equipment (UE). For this, the UE persistently measures a quality of a serving cell currently providing a service and a quality of a neighboring cell. The UE reports a measurement result to a network at a proper time. The network provides an optimal mobility to the UE by using a handover or the like.

To provide information which can be helpful when a network operator manages a network in addition to the purpose of supporting the mobility, the UE may perform a measurement with a specific purpose determined by the network, and may report the measurement result to the network. For example, the UE may receive broadcast information of a specific cell determined by the network. On the basis thereof, the UE may report to a serving cell a cell identity (also referred to as a global cell identity) of the specific cell, location identification information of the specific cell (e.g., a tracking area code), and/or other cell information (e.g., whether it is a member of a closed subscriber group (CSG) cell).

If the UE on the move confirms that a quality of a specific region is significantly poor through the measurement, the UE may report a measurement result and location information regarding cells having a poor quality to the network. The network may attempt to optimize the network on the basis of the measurement result reported from UEs which assist the network operation.

Meanwhile, conventionally, when a plurality of serving cells are configured in the UE, it is premised that each serving cell has a different frequency band. However, a future mobile communication system can configure the plurality of serving cells in the UE in the same frequency band. For example, a plurality of small cells having a narrow coverage may be deployed in a macro cell having a wide coverage. If the macro cell and the small cells use the same frequency band and the UE is located in the small cell, the plurality of serving cells may be configured in the UE in the same frequency band.

The UE may transmit a quality measurement result for each serving cell to a base station if a specific condition is satisfied. However, if the plurality of serving cells are configured in the UE in the same frequency band, there may be a problem in that the UE does not know which serving cell is used as a basis of determining whether the specific condition is satisfied.

### SUMMARY OF THE INVENTION

After performing a measurement on serving cells, if a determined measurement report criterion is satisfied, a user equipment (UE) may report a measurement result to a network. In this case, a conventional measurement report criterion is primarily based on a quality value of the serving cell of the UE. However, unlike in the conventional technique in which only one serving cell can be configured in the UE or in which serving cells having different frequencies can be configured, a plurality of cells can be configured in the UE in the same frequency band. In this case, according to the conventional technique, there is a problem in that which serving cell is used as a basis of determining whether a measurement report criterion is satisfied is ambiguous or unknown.

The present invention provides a method of reporting a quality measurement in such a manner that a UE in which a plurality of serving cells are configured in the same frequency band provides which serving cell is used as a basis of determining whether a measurement report criterion is satisfied, and an apparatus for the method.

In an aspect, provided is a method of performing a quality measurement report of a user equipment (UE) in which a plurality of serving cells are configured in the same frequency band, the method comprising: receiving measurement configuration information, performing a quality measurement on some or all of the plurality of serving cells according to the measurement configuration information, determining whether a measurement report criterion is satisfied on the basis of a result of the quality measurement and transmitting a report message containing the result of the quality measurement if the measurement report criterion is satisfied, wherein the measurement configuration information contains reference information, and wherein the reference information indicates a reference cell for determining whether the measurement report criterion is satisfied.

The measurement configuration information contains measurement object information indicating an object for which the UE will perform the measurement and reporting configuration information for reporting the measurement report criterion, and wherein the reference information is contained in the reporting configuration information.

The reference information indicates a specific serving cell among the plurality of serving cells as the reference cell.

The report message is transmitted if the measurement report criterion is satisfied for the specific serving cell.

The reference information indicates all of the plurality of serving cells as the reference cell.

The report message is transmitted if even one serving cell among the plurality of serving cells satisfies the measurement report criterion.

The reference information indicates all secondary serving cells among the plurality of serving cells as the reference cell.

The report message is transmitted if even one secondary serving cell among the plurality of serving cells satisfies the measurement report criterion.

The secondary serving cell is a serving cell which does not provide a radio resource control (RRC) function and signaling to the UE.

In another aspect, provided is UE in which a plurality of serving cells are configured in the same frequency band, the UE comprising: a reception module for receiving measurement configuration information from a network, a processor for controlling a quality measurement operation according to the measurement configuration information received through the reception module, wherein the processor is configured for: performing a quality measurement on some or all of the plurality of serving cells according to the measurement configuration information, determining whether a measurement report criterion is satisfied on the basis of a result of the quality measurement and transmitting a report message containing the result of the quality measurement if the measurement report criterion is satisfied, wherein the measurement configuration information contains reference information, and wherein the reference information indicates a reference cell for determining whether the measurement report criterion is satisfied.

A user equipment (UE) in which a plurality of serving cells are configured in the same frequency band can determine whether a measurement criterion report is satisfied according to a precise criterion. Therefore, an ambiguity can be decreased when a quality measurement result value is shared between a base station and the UE.

### BRIEF DESCRIPTION OF THE DRAWINGS

FIG. 1 shows a network structure of an evolved universal terrestrial radio access network (E-UTRAN) as an example of a mobile communication system.

FIG. 2 and FIG. 3 show a structure of a radio interface protocol between a UE and an E-UTRAN on the basis of a3GPP radio access network protocol.

FIG. 4 is a picture for describing radio link failure procedure.

FIG. 5 and FIG. 6 show success and failure cases of an RRC connection re-establishment procedure.

FIG. 7 shows a procedure in which a UE performs a measurement to report to a network in a 3GPP LTE system.

FIG. 8 shows an example of a measurement configuration configured in a UE.

FIG. 9 shows an example of deleting a measurement identity.

FIG. 10 shows an example of deleting a measurement object.

FIG. 11 is a drawing for describing the aforementioned measurement operation in summary.

FIG. 12 is a drawing for describing a carrier aggregation technique applied to a 3GPP LTE-A system.

FIG. 13 is a drawing for describing a definition on a cell from a perspective of a UE when a carrier aggregation technique is applied.

FIG. 14 shows an example in which a plurality of cells exist in the same frequency band.

FIG. 15 shows a method of performing a measurement report of a UE according to an embodiment of the present invention.

FIG. 16 shows an example in which a plurality of serving cells are configured in a UE in the same frequency band.

FIG. 17 shows an example of a measurement configuration configured in a UE to which a plurality of serving cells are configured in the same frequency band as shown in FIG. 16 according to the present invention.

FIG. 18 shows a structure of a wireless communication system including a UE and an eNB according to the present invention.

### DESCRIPTION OF EXEMPLARY EMBODIMENTS

Hereinafter, embodiments of the present invention will be described in detail with reference to the accompanying drawings. The details to be described hereinafter with reference to the accompanying drawings are not unique embodiments but exemplary embodiments. For example, although it is described hereinafter that a mobile communication system is a 3^{rd} generation partnership project (3GPP) long term evolution (LTE) system, the present invention is also applicable variously as a method of effectively measuring transmission of a user equipment (UE) in various mobile communication systems such as an institute of electrical and electronics engineers (IEEE) 802.16-based system or the like to which a carrier aggregation technique can be applied.

Meanwhile, the details to be described hereinafter include specific aspects to provide perfect understandings of the present invention. However, it will be apparent to those ordinarily skilled in the art that the present invention can be implemented without the specific aspects. In some cases, to avoid conceptual ambiguity of the present invention, well-known structures and apparatuses can be omitted, or a block diagram can be illustrated by focusing on a core function of each structure and apparatus. In addition, like reference numerals are used to indicate like elements throughout the present invention.

In the following description, a ‘measurement’ may be defined as a measurement of a quality value of a corresponding cell by receiving a reference signal received from inter-frequency, intra-frequency, and inter-RAT cells according to a measurement configuration received by a UE from a network. In addition, in the following description, a ‘quality’ implies a signal quality or cell quality recognized through a reference signal received from a measurement object cell.

As described above, hereinafter, it will be described a method in which a UE performs a quality measurement report on the basis of a specific reference cell among a plurality of serving cells configured in the UE in a mobile communication system using a carrier aggregation technique, and a UE apparatus for the method. For this, a 3GPP LTE system is first described in brief as an example of a mobile communication system for applying this technique.

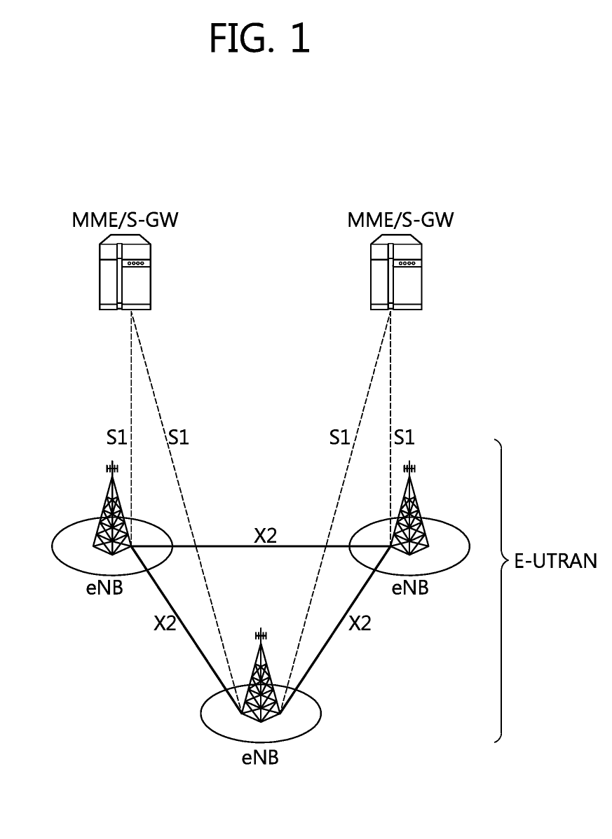

FIG. 1 shows a network structure of an evolved universal terrestrial radio access network (E-UTRAN) as an example of a mobile communication system. An E-UTRAN system is evolved from the legacy UTRAN system, and its basic standardization work is carried out in the current 3GPP. The E-UTRAN system is also referred to as a long term evolution (LTE) system.

The E-UTRAN consists of e-NodeBs (eNBs or base stations). The eNBs are connected with each other through an X2 interface. The eNB is connected to a user equipment (hereinafter, UE) through a radio interface, and is connected to an evolved packet core (EPC) through an S1 interface.

EPC comprises MME (Mobility Management Entity), S-GW (Serving-Gateway) and PDN-GW (Packet Data Network-Gateway). The MME has access information of the UE or information regarding capacity of the UE, and the information is frequently used in mobility management of the UE. The S-GW is a gateway having the E-UTRAN as an end point, and the P-GW is a gateway having the PDN as an end point.

Layers of a radio interface protocol between the UE and the network may be divided into a first layer L1, a second layer L2, and a third layer L3 based on three lower layers of an open system interconnection (OSI) standard model which is widely known in the communication system, and among them, a physical layer to which the first layer belongs provides an information transfer service using a physical channel, and a radio resource control (RRC) layer positioned on the third layer serves to control a radio resource between the UE and the network. To this end, the RRC layer exchanges an RRC message between the UE and the network.

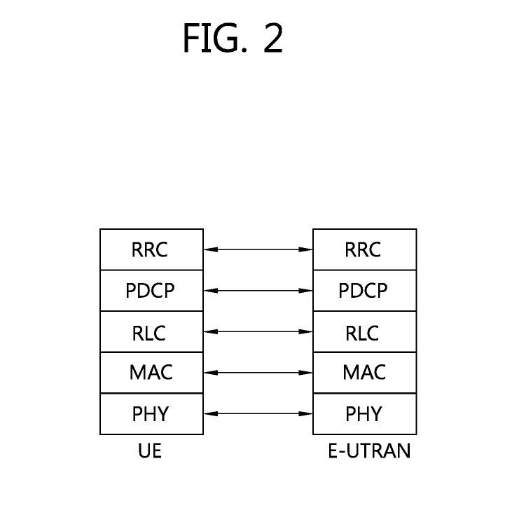

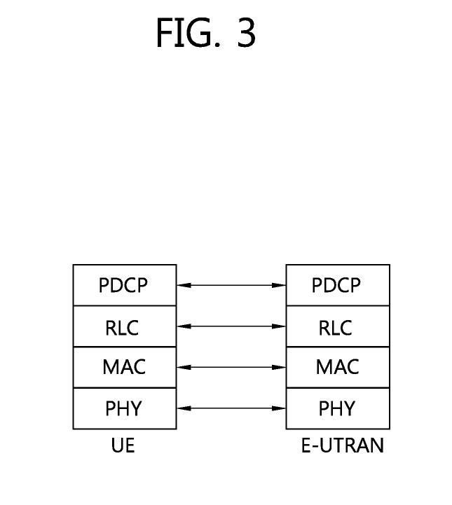

FIG. 2 and FIG. 3 show a structure of a radio interface protocol between a UE and an E-UTRAN on the basis of a 3GPP radio access network protocol.

The radio interface protocol horizontally includes a physical layer, a data link layer, and a network layer, and vertically includes a user plane (U-plane) for data information transfer and a control plane (C-plane) for control signaling delivery. Protocol layers of FIG. 2 and FIG. 3 can be classified into a first layer (L1), a second layer (L2), and a third layer (L3) on the basis of lower three layers of an open system interconnection (OSI) model that is well-known in the communication system. A pair of radio protocol layers exits between the UE and the UTRAN and serves to transmit data of a radio link.

Hereinafter, each of the radio protocol layers of the control plane of FIG. 2 and the user plane of FIG. 3 will be described.

A physical layer, i.e., a first layer, provides an upper layer with an information transfer service by using a physical channel. The physical layer is connected to a media access control (MAC) layer, i.e., an upper layer of the physical layer, via a transport channel. Data is transferred between the MAC layer and the physical layer through the transport channel. The data move between different PHY layers, that is, the PHY layers of the transmitter and the receiver through the physical channel. The physical channel may be modulated by an orthogonal frequency division multiplexing (OFDM) scheme, and use a time and a frequency as the radio resource.

The medium access control (hereinafter, MAC) layer in a second layer provides services to a radio link control (RLC) layer, i.e., an upper layer of the MAC layer, through a logical channel. A radio link control (hereinafter, RLC) layer in the second layer supports reliable data transfer. Functions of the RLC layer may be implemented as a function block included in the MAC layer. In this case, the RLC layer may not exist. A packet data convergence protocol (PDCP) layer in the second layer performs a header compression function for decreasing an Internet protocol (IP) header size containing relatively large and unnecessary control information in order to effectively transmit the IP packet through a radio interface when transmitting an IP packet such as an IPv4 packet or an IPv6 packet.

A radio resource control (hereinafter, RRC) layer in a third layer is defined only in the control plane. The RRC layer serves to control the logical channel, the transport channel, and the physical channel in association with configuration, reconfiguration, and release of radio bearers (RBs). In this case, the RB is a service provided by the second layer for data delivery between the UE and the E-UTRAN. When RRC connection is established between the RRC layer of the UE and the RRC layer of the E-UTRAN, the UE is in an RRC connected state, and if not, the UE is in an RRC idle state.

A downlink transport channel for transporting the data to the UE from the network includes a broadcast channel (BCH) for transporting system information and a downlink shared channel (SCH) for transporting user traffic or a control message. The traffic or the control message of a downlink multicast or broadcast service may be transported through the downlink SCH, or may be transported through a separate downlink multicast channel (MCH). Meanwhile, an uplink transport channel for transporting the data from the UE to the network includes a random access channel (RACH) for transporting an initial control message and an uplink shared channel (SCH) for transporting the user traffic or the control message in addition to the RACH.

A logical channel which is above the transport channel and mapped in the transport channel includes a broadcast control channel (BCCH), a paging control channel (PCCH), a common control channel (CCCH), a multicast control channel (MCCH), a multicast traffic channel (MTCH), and the like.

The physical channel is constituted by several OFDM symbols in a time domain and several sub-carriers in a frequency domain. One sub-frame is constituted by a plurality of OFDM symbols in the time domain. The RB as a resource allocation unit is constituted by a plurality of OFDM symbols and a plurality of sub-carriers. Further, each sub-frame may use specific sub-carriers of specific OFDM symbols (for example, first OFDM symbols) of the corresponding sub-frame for the physical downlink control channel (PDCCH), that is, a L1/L2 control channel. One subframe may consist of two slots having a length of 0.5 ms, which may correspond to lms equivalent to a transmission time interval (TTI) as a unit time in which data is transmitted.

Next, system information in an LTE system will be described. The system information includes necessary information which must be known to a UE to access an eNB. Thus, the UE has to receive all pieces of system information before accessing the eNB. Further, the UE must always have recent system information. Since the system information is information which must be known to all UEs in one cell, the eNB periodically transmits the system information.

The system information is classified into a master information block (MIB), a scheduled block (SB), and a system information block (SIB). The MIB allows the UE to know a physical configuration (e.g., bandwidth) of a specific cell. The SB reports transmission information (e.g., a transmission period or the like) of SIBs. The SIB is a group of a plurality of pieces of system information related to each other. For example, one SIB includes only information of a neighbor cell, and another SIB includes only information of an uplink radio channel used by the UE.

Meanwhile, a service provided by the network to the UE may be classified into three types to be described below. The UE recognizes a cell type differently according to which service can be provided. A service type is first described below, and then the cell type will be described.

1) Limited service: This service provides an emergency call and an earthquake and tsunami warning system (ETWS), and can be provided in an acceptable cell.

2) Normal service: This service denotes a public use service for general use, and can be provided in a suitable cell.

3) Operator service: This service denotes a service for a network operator, and a corresponding cell can be used only by the network operator and cannot be used by a normal user.

A service type provided by a cell can be identified as follows.

1) Acceptable cell: A UE can receive a limited service in this cell. This cell is not barred from the perspective of the UE, and satisfies a cell selection criterion of the UE.

2) Suitable cell: The UE can receive a normal service in this cell. This cell satisfies a condition of an acceptable cell, and also satisfies additional conditions. Regarding the additional conditions, this cell must belong to a PLMN to which the UE can access, and a tracking area update procedure of the UE must not be barred in this cell. If a specific cell is a CSG cell, this cell must be accessible by the UE as a CSG member.

3) Barred cell: This is a cell which uses system information to broadcast that the cell is a barred cell.

4) Reserved cell: This is a cell which uses system information to broadcast that the cell is a reserved cell.

Hereinafter, an RRC state of the UE and an RRC connection method will be described. The RRC state means whether the RRC layer of the UE is logical-connected with the RRC layer of the E-UTRAN or not, and a case where the RRC layer of the UE is connected with the RRC layer of the E-UTRAN is called a RRC connection state, and a case where the RRC layer of the UE is not connected with the RRC layer of the E-UTRAN is called an RRC idle state. Since the RRC connection exists in the UE in the RRC connection state, the E-UTRAN may determine the existence of the corresponding UE in a cell unit, and as a result, the UE may be efficiently controlled. On the other hand, the UE in the RRC idle state may not be determined by the E-UTRAN, and a core network (CN) is managed by a tracking area unit which is a larger area unit than the cell. That is, in the UE in the RRC idle state, only the existence is determined by a large area unit, and the UE needs to move in the RRC connection state in order to receive a general mobile communication service such as voice or data

When the user first turns on the power of the UE, the UE first searches a proper cell and then stays in the RRC idle state in the corresponding cell. The UE in the RRC idle state establishes the RRC connection with the E-UTRAN through an RRC connection procedure only when the RRC connection is required, and is transited into the RRC connection state. There are several cases where the UE in the RRC idle state requires the RRC connection, and for example, uplink data transmission is required due to reasons such as user's call attempt, or a response message to a case where a paging message is received from the E-UTRAN is transmitted.

A non-access stratum (NAS) layer positioned above the RRC layer performs functions such as a session management and a mobility management.

In the NAS layer, in order to manage mobility of the UE, two states of EDEPS mobility management-REGISTERED (EMM-REGISTER) and EMM-DEREGISTERED are defined, and the two states are applied to the UE and the MME. The initial UE is in the EMM-DEREGISTERED state, and the UE performs a procedure of registering the UE in the corresponding network through an initial attaching procedure so as to be connected to the network. When the attaching procedure is successfully performed, the UE and the MME are in the EMM-REGISTERED state.

In order to manage signaling connection between the UE and the EPS, two states of an EPS connection management (ECM)-IDLE state and an ECM-CONNECTED state, and the two states are applied to the UE and the MME. When the UE in the ECM-IDLE state is RRC-connected with the E-UTRAN, the corresponding UE becomes in the ECM-CONNECTED state. When the MME in the ECM-IDLE state is S1-connected with the E-UTRAN, the corresponding MME becomes in the ECM-CONNECTED state. When the UE is in the ECM-IDLE state, the E-UTRAN does not have context information of the UE. Accordingly, the UE in the ECM-IDLE state performs a procedure related with the mobility based on the UE such as cell selection or cell reselection without receiving a command of the network. On the contrary, when the UE is in the ECM-CONNECTED state, the mobility of the UE is managed by the command of the network. When a position of the UE in the ECM-IDLE state is different from a position which is known to the network, the UE notifies the corresponding position of the UE to the network through a tracking area updating procedure.

Meanwhile, a radio link failure procedure in a 3GPP LTE system will be described.

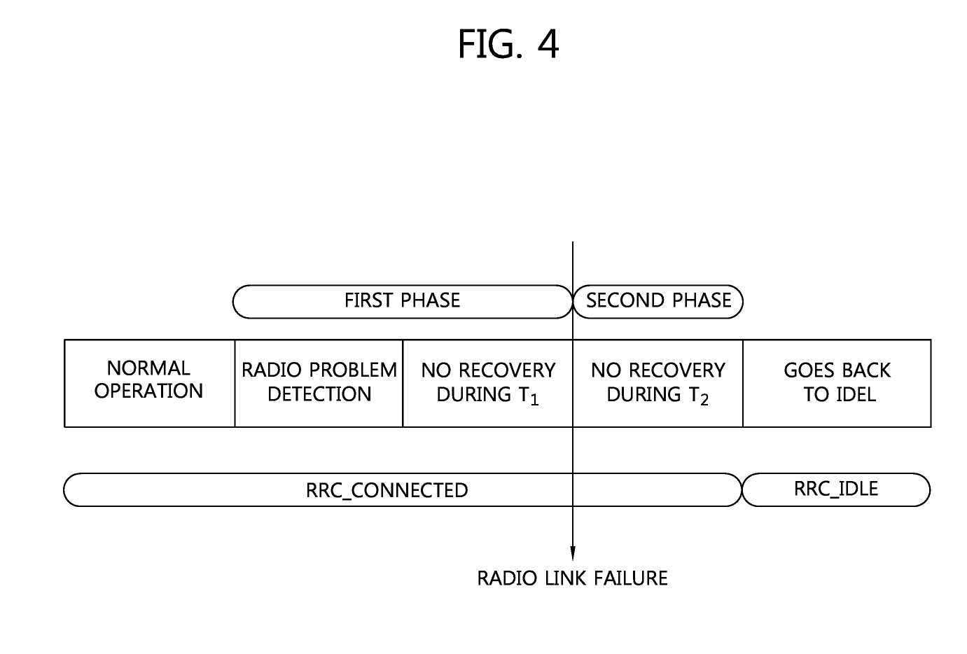

A UE persistently performs a measurement to maintain a communication link quality with a cell in which the UE receives a service. In particular, the UE determines whether the communication link quality with the cell in which the UE currently receives and provides the service is in a communication disabled situation. If it is determined that the quality of the current cell is so poor that communication is impossible at present, the UE declares a radio link failure. If the UE declares the radio link failure, the UE gives up maintaining of communication with this cell, selects a cell through a cell selection procedure, and thereafter attempts an RRC connection reconfiguration. As such, an operation related to the radio link failure may be described in two phases as shown in FIG. 4.

In a first phase, the UE examines whether a current communication link has a problem. If there is the problem, the UE declares a radio link problem, and waits until this communication link is recovered during a specific time T₁. If the link is recovered during this time, the UE continues a normal operation. If the radio link problem is not recovered during the time T₁ in the first phase, the UE declares the radio link failure, and enters a second phase. In the second phase, the UE performs an RRC connection re-establishment procedure to recover from the radio link failure.

The RRC connection re-establishment procedure is a procedure of reconfiguring an RRC connection again in an RRC_CONNECTED state. Since the UE remains in the RRC_CONNECTED state, that is, does not enter an RRC_IDLE state, the UE does not initiate all radio configurations (e.g., radio bear configurations) thereof. Instead, the UE temporarily suspends the use of all radio bearers except for an SRB0 when starting the RRC connection re-establishment procedure. If the RRC connection reconfiguration is successful, the UE resumes the use of the radio bearers of which the use is temporarily suspended.

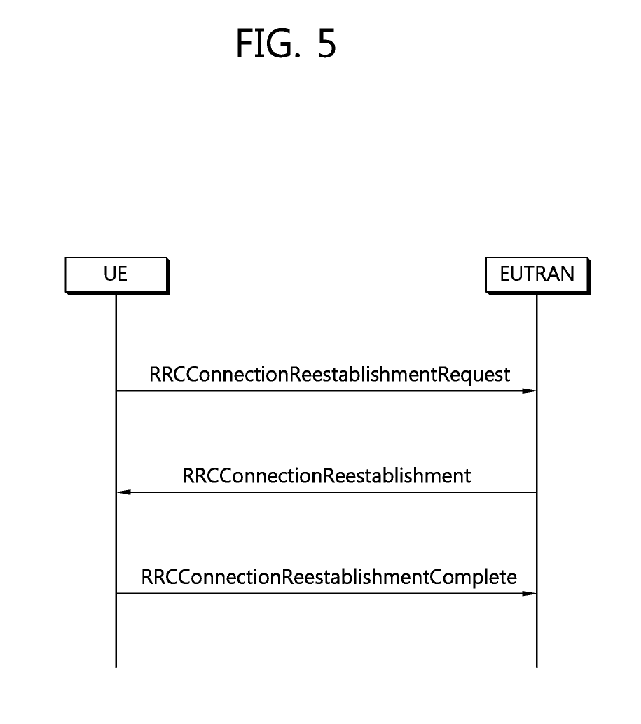

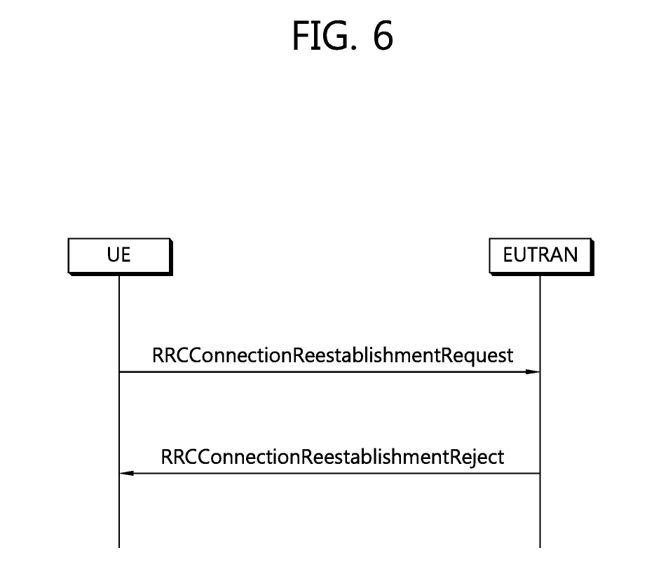

FIG. 5 and FIG. 6 show success and failure cases of an RRC connection re-establishment procedure.

Referring to FIG. 5 and FIG. 6, an operation of a UE in an RRC connection re-establishment procedure will be described. First, the UE performs a cell selection to select one cell. In the selected cell, the UE receives system information to receive basic parameters for a cell access. Subsequently, the UE attempts an RRC connection re-establishment through a random access procedure. If a cell selected by the UE through the cell selection is a cell having a context of the UE, that is, a prepared cell, the cell may accept an RRC connection re-establishment request of the UE, and thus the RRC connection re-establishment procedure may be successful. However, if the cell selected by the UE is not the prepared cell, since the cell does not have the context of the UE, the RRC connection re-establishment request of the UE cannot be accepted. Therefore, the RRC connection re-establishment procedure fails.

Hereinafter, a quality measurement procedure in a 3GPP LTE system will be described.

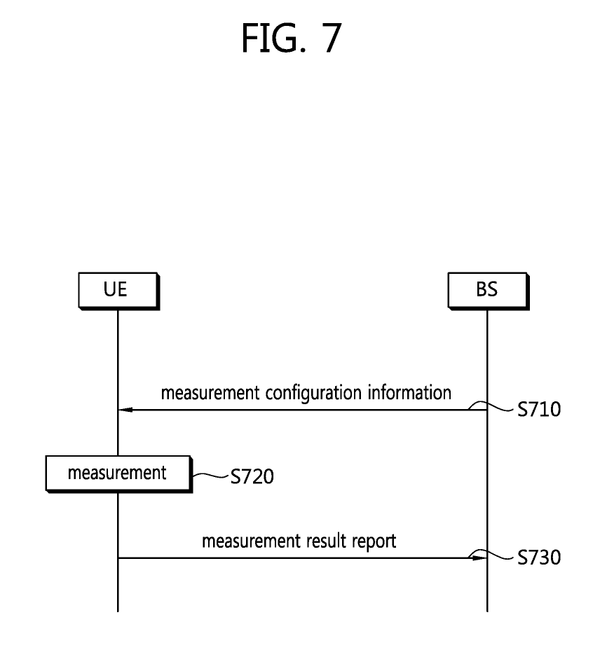

FIG. 7 shows a procedure in which a UE performs a measurement to report to a network in a 3GPP LTE system.

First, the UE may receive measurement configuration information from a BS (S710). Hereinafter, a message including the measurement configuration information is called a measurement configuration message. The UE may perform a measurement on the basis of the measurement configuration information (S720). If a measurement result satisfies a report condition in the measurement configuration information, the UE may report a measurement result to the BS (S730). Hereinafter, a message including the measurement result is called a measurement report message.

Meanwhile, the measurement configuration message received from the BS may have the following structure.

TABLE 1
RRCConnectionReconfiguration-r8-IEs ::= SEQUENCE {

| | | |
|---|---|---|
| measConfig | MeasConfig | OPTIONAL, |
| -- Need ON | | |
| } | | |

| | |
|---|---|
| MeasConfig ::= | SEQUENCE { |

-- Measurement objects

| | |
|---|---|
| measObjectToRemoveList | MeasObjectToRemoveList |
| OPTIONAL, -- Need ON | |
| measObjectToAddModList | MeasObjectToAddModList |
| OPTIONAL, -- Need ON | |
| -- Reporting configurations | |
| reportConfigToRemoveList | ReportConfigToRemoveList |
| OPTIONAL, -- Need ON | |

| | |
|---|---|
| reportConfigToAddModList | ReportConfigToAddModList |
| OPTIONAL, -- Need ON | |
| -- Measurement identities | |

| | |
|---|---|
| measIdToRemoveList | MeasIdToRemoveList |
| OPTIONAL, -- Need ON | |
| measIdToAddModList | MeasIdToAddModList |
| OPTIONAL, -- Need ON | |
| -- Other parameters | |
| quantityConfig | QuantityConfig |
| OPTIONAL, -- Need ON | |

| | |
|---|---|
| measGapConfig | MeasGapConfig |
| OPTIONAL, -- Need ON | |
| s-Measure | RSRP-Range |
| OPTIONAL, -- Need ON | |

| | |
|---|---|
| preRegistrationInfoHRPD | PreRegistrationInfoHRPD |
| OPTIONAL, -- Need OP | |

| | |
|---|---|
| speedStatePars | CHOICE { |

| | |
|---|---|
| release | NULL, |

| | |
|---|---|
| setup | SEQUENCE { |

```
        mobilityStateParameters
  MobilityStateParameters,
```

| | |
|---|---|
| timeToTrigger-SF | SpeedStateScaleFactors |
| } | |

| | |
|---|---|
| } | OPTIONAL, |
| -- Need ON | |
| ... | |
| } | |

The measurement configuration information in the measurement configuration message exemplified in Table 1 above will be described as follows.

(1) Measurement object information: The measurement object information is information on an object for which the UE is to perform a measurement. A measurement object may include at least one of an intra-frequency measurement object which is an object of an intra-cell measurement, an inter-frequency measurement object which is an object of an inter-cell measurement, and an inter-RAT measurement object which is an object of an inter-RAT measurement. For example, the intra-frequency measurement object may indicate the neighbor cell having the same frequency band as the serving cell, the inter-frequency measurement object may indicate the neighbor cell having the different frequency band from the serving cell, and the inter-RAT measurement object may indicate a neighbor cell of RAT different from the RAT of the serving cell.

(2) Reporting configuration information: The reporting configuration information is information on a reporting condition and a reporting type regarding the time when the UE reports the measurement result. The reporting condition may include information on an event or a cycle in which reporting the measurement result is triggered. The reporting type is information regarding a configuration type of the measurement result.

(3) Measurement identity information: The measurement identity information is information regarding a measurement identity that determines a measurement object, a reporting time, and a reporting type by the UE by associating the measurement object and the reporting configuration with each other. The measurement identity information is included in the measurement reporting message to represent a measurement object of the measurement result and a reporting condition of the measurement reporting which occurs.

(4) Quantity configuration information: The quantity configuration information is information on a parameter for configuring filtering of a measurement unit, a reporting unit, and/or a measurement result value.

(5) Measurement gap information: The measurement gap information is information on a measurement gap which is an interval which the UE may use for only measurement without considering data transportation with the serving cell because downlink transportation or uplink transportation is not scheduled.

The UE may have a measurement object list, a measurement reporting configuration list, and a measurement identity list in order to perform a measurement procedure.

In the 3GPP LTE, the base station may configure only one measurement object for one frequency band to the UE. According to Clause 5.5.4 of 3GPP TS 36.331 V8.5.0 (2009-03) “Evolved Universal Terrestrial Radio Access (E-UTRA) Radio Resource Control (RRC); Protocol specification (Release 8)”, events that trigger the measurement reporting shown in the following table are defined.

TABLE 2

| Event | Report condition |
|---|---|
| Event A1 | Serving becomes better than threshold |
| Event A2 | Serving becomes worse than threshold |
| Event A3 | Neighbor becomes offset better than serving |
| Event A4 | Neighbor becomes better than threshold |
| Event A5 | Serving becomes worse than threshold1 and neighbor |
| | becomes better than threshold2 |
| Event B1 | Inter RAT neighbor becomes better than threshold |
| Event B2 | Serving becomes worse than threshold1 and inter RAT |
| | neighbor becomes better than threshold2 |

When the measurement result of the UE satisfies the configured event, the UE transports the measurement reporting message to the base station.

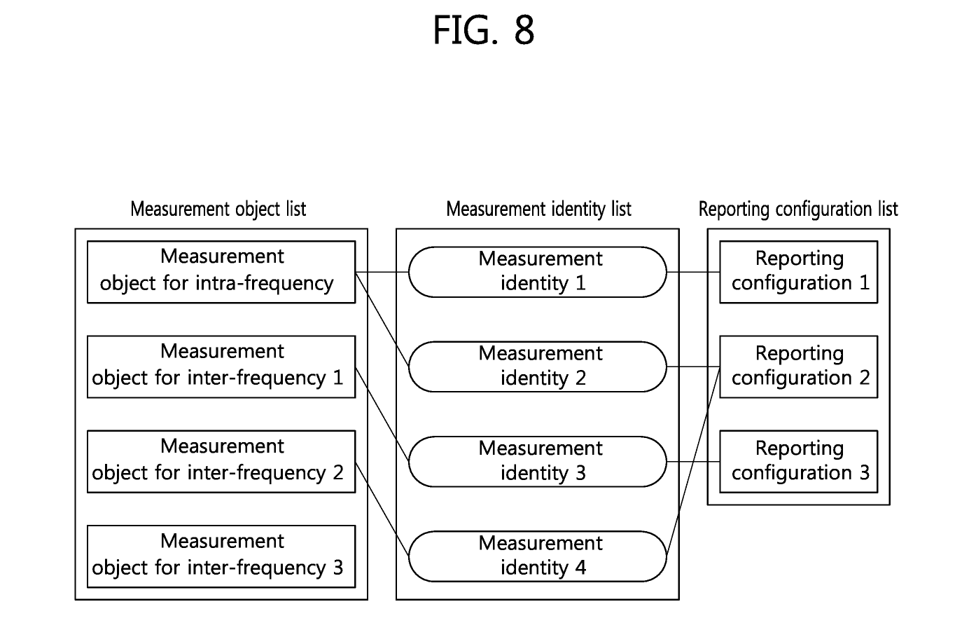

FIG. 8 shows an example of a measurement configuration configured in a UE.

In the example of FIG. 8, First, measurement identity 1 connects the intra-frequency measurement object and reporting configuration 1. The UE performs intra frequency measurement and the reporting configuration 1 is used to determine a reference and a reporting type of reporting the measurement result.

Measurement identity 2 is connected with the intra-frequency measurement object similarly to the measurement identity 1, but the intra-frequency measurement object is reporting configuration 2. The UE performs measurement and the reporting configuration 2 is used to determine the reference and the reporting type of reporting the measurement result.

By the measurement identity 1 and the measurement identity 2, the UE transports the measurement result even though the measurement result for the intra-frequency measurement object satisfies any one of the reporting configuration 1 and the reporting configuration 2.

Measurement identity 3 connects inter-frequency measurement object 1 and reporting configuration 3. When a measurement result for the inter-frequency measurement object 1 satisfies a reporting condition included in the reporting configuration 1, the UE reports the measurement result.

Measurement identity 4 connects the inter-frequency measurement object 2 and the reporting configuration 2. When a measurement result for the inter-frequency measurement object 2 satisfies a reporting condition included in the reporting configuration 2, the UE reports the measurement result.

Meanwhile, the measurement object, the reporting configuration, and/or the measurement identity may be added, changed, and/or deleted. These may be instructed when the base station sends a new measurement configuration message or a measurement configuration change message to the UE.

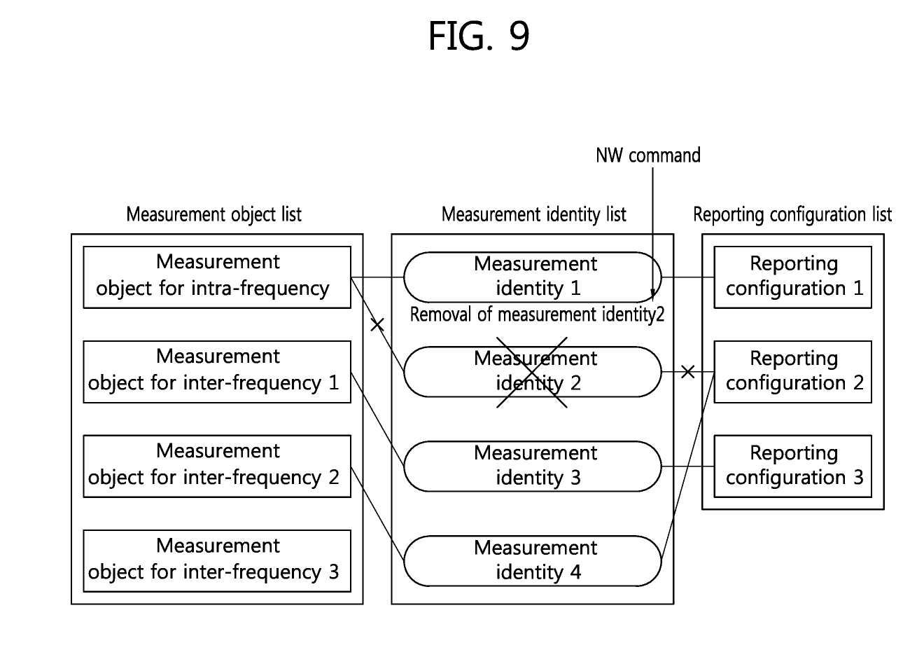

FIG. 9 shows an example of deleting a measurement identity.

In FIG. 9, a “NW command” may be a measurement configuration message or a measurement configuration change message which instructs to delete a measurement identity 2. If the measurement identity 2 is deleted, measurement for a measurement object associated with the measurement identity 2 902 is stopped and a measurement report is not transported. A measurement object or a reporting configuration associated with the deleted measurement identity may not be changed.

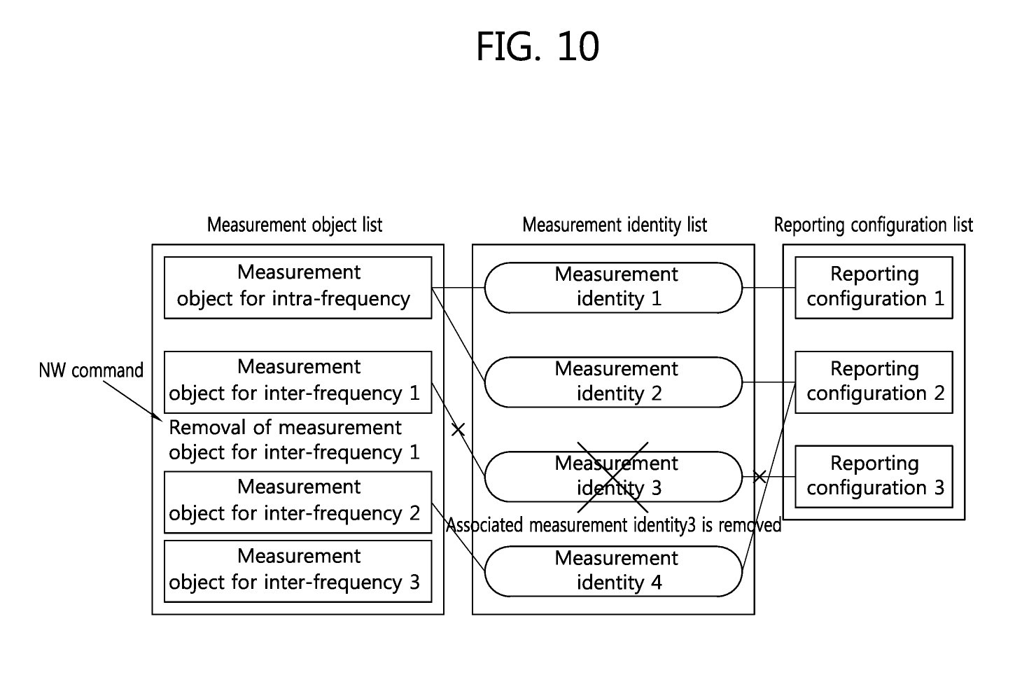

FIG. 10 shows an example of deleting a measurement object.

In FIG. 10, a “NW command” may be a measurement configuration message or a measurement configuration message which instructs to delete an inter-frequency measurement object 1. If the inter-frequency measurement object 1 is deleted, a UE may also delete a related measurement identity 3. Accordingly, a measurement for the inter-frequency measurement object 1 is suspended, and a measurement report may not be transmitted. However, a report configuration related to the deleted inter-frequency measurement object 1 may not be changed or deleted.

When the reporting configuration is removed, the UE removes even a measurement identity associated therewith. The UE stops measurement for an associated measurement object by the associated measurement identity. However, the measurement object associated with the deleted reporting configuration may not be changed or deleted.

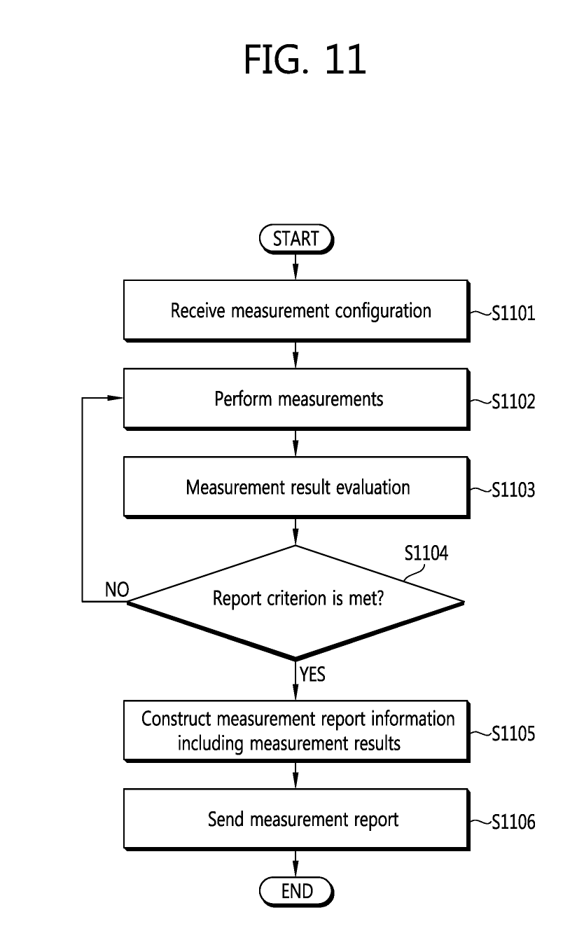

FIG. 11 is a drawing for describing the aforementioned measurement operation in summary.

A UE may receive measurement configuration information from an eNB (or a network) (S1101). As described above with reference to Table 1 above, the measurement configuration information may include measurement object information, reporting configuration information, measurement identity information, quantity configuration information, and measurement gap information. In addition, as described above with reference to FIG. 9 and FIG. 10, the measurement configuration information may include information such as a specific measurement object and/or a specific measurement identity deletion/addition or the like.

The UE may perform a quality measurement according to the received measurement configuration information (S1102). Accordingly, the UE may perform a measurement result evaluation procedure for determining whether a quality measurement result value satisfies a quality report criterion (S1103). In this case, an evaluation criterion may use methods shown in Table 2 above. If the measurement result satisfies the report criterion (S1104), the UE may construct measurement report information including the measurement result (S1105), and may transmit the information to the eNB (i.e., the network) (S1106). An exemplary structure of the measurement report message that can be used when it is applied to the 3GPP LTE system is as follows.

TABLE 3

| | |
|---|---|
| MeasResults ::= | SEQUENCE { |
| measId | MeasId, |
| measResultServCell | SEQUENCE { |
| rsrpResult | RSRP-Range, |
| rsrqResult | RSRQ-Range |
| }, | |
| measResultNeighCells | CHOICE { |
| measResultListEUTRA | SEQUENCE (SIZE |
| (1..maxCellReport)) OF | |
| physCellId | PhysCellId, |
| measResult | SEQUENCE { |
| rsrpResult | RSRP-Range |
| OPTIONAL, | |
| rsrqResult | RSRQ-Range |
| OPTIONAL, | |
| ..., | |
| } | |
| } | |

Information included in the measurement report message exemplified in Table 3 above may be as follows.

measurement identity (measId): It is a measurement identity related to the report configuration of which the report criterion is satisfied. The network may know which criterion is used to transmit the measurement report received from the UE through this measurement identity.

measured serving cell's quality value (measResultServCell): It is a quality value of a serving cell measured by the UE. For example, it may include a reference signal received power (RSRP) and a reference signal received quality (RSRQ).

measured neighbour cell's information (measResultNeighCells): It is a measurement identity of a neighbour cell measured by the UE, and includes the followings.

neighbour cell identity (physCellId): In general, it is a physical cell identity (e.g., PCI for E-UTRAN) of a neighbour cell satisfying a report criterion.

neighbour cell's quality value (measResult): In general, it is a quality value (e.g., RSRP, RSRQ) of a neighbour cell satisfying a report criterion.

When conforming to the aforementioned example, the UE effectively measures a quality of a serving cell and/or a neighbour cell and reports this to the eNB, thereby ensuring a mobility of the UE. However, one embodiment of the present invention proposes an effective quality measurement operation when the UE has a plurality of serving cells at the same time in addition to the aforementioned measurement operation. For this, as an example of a case where the UE has the plurality of serving cells, a carrier aggregation technique which is under discussion in the 3GPP LTE-A standard will be described.

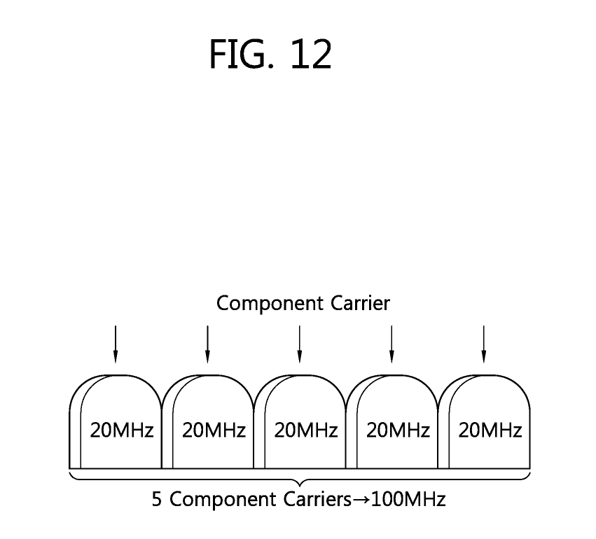

FIG. 12 is a drawing for describing a carrier aggregation technique applied to a 3GPP LTE-A system.

An LTE-A technical standard is an IMT-advanced candidate technique of an international telecommunication union (ITU), and is designed to conform to an IMT-advanced technical requirement of the ITU. Accordingly, it is under discussion in LTE-A to extend a bandwidth in comparison with the legacy LTE system in order to satisfy the ITU requirement. To extend the bandwidth in the LTE-A system, a carrier that can be used in the legacy LTE system is defined as a component carrier (hereinafter, CC), and it has been discussed that up to 5 CCs can be used through aggregation. Since a CC may have a bandwidth of up to 20 MHz as in the LTE system, the bandwidth can be extended to up to 100 MHz in this concept. A technique of using a plurality of CCs through aggregation is called a carrier aggregation (CA).

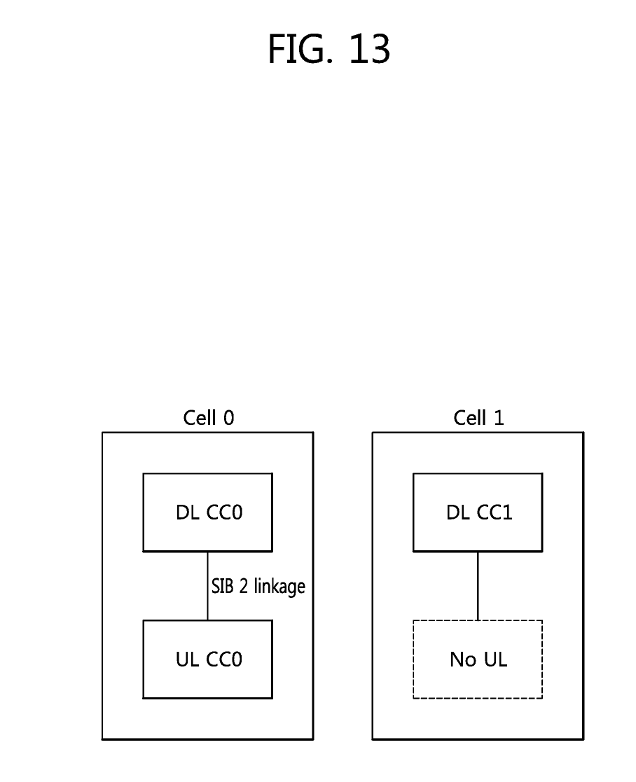

FIG. 13 is a drawing for describing a definition on a cell from a perspective of a UE when a carrier aggregation technique is applied.

When a carrier aggregation (CA) is applied as described above with reference to FIG. 12, a plurality of CCs may be included for each of a downlink (DL) and an uplink (UL). In this system, from a perspective of the UE, each of an aggregation of a DL CC and a UL CC (i.e., a cell 0 of FIG. 13) or only a DL CC (i.e., a cell 1 of FIG. 13) may be regarded as a cell. As shown in FIG. 13, a linkage between the DL CC and the UL CC may be indicated through system information transmitted using a DL resource. That is, the system information of a mobile communication system to which the CA is applied includes information regarding the linkage between the UL CC and the DL CC additionally in the aforementioned system information, which is shown as an SIB2 link in FIG. 13.

Meanwhile, a concept in which CCs for transmitting all control signaling are referred to as a primary cell in distinction from other CCs is proposed in an LTE-A system. A UL primary CC and a DL primary CC are configured in each UE, and an aggregation of the UL primary CC used in UL control information transmission and the DL primary CC used in DL control information transmission may be referred to as a primary cell or a PCell. In addition to the primary cell or PCell described above, cells configured in the UE may also be referred to as a secondary cell or an SCell.

Now, the present invention will be described.

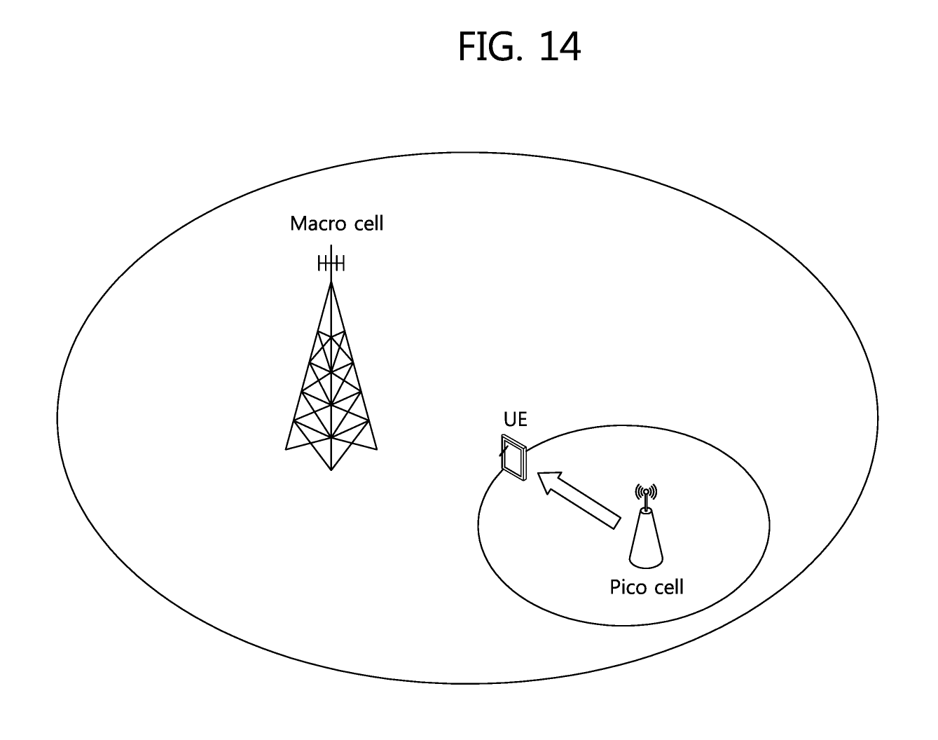

FIG. 14 shows an example in which a plurality of cells exist in the same frequency band.

Referring to FIG. 14, a UE may exist in a coverage of a macro cell while also existing in a coverage of a pico cell. The macro cell and the pico cell may perform communication with the UE by using the same frequency. In this case, from a perspective of the UE, two serving cells exist in the same frequency.

Meanwhile, events in which a measurement report is trigged are described in Table 2 by considering a fact that only one serving cell exists in the same frequency. Therefore, in a case where a plurality of serving cells exist in the same frequency, there may be a problem as to which serving cell is used as a basis when a UE determines whether the events of Table 2 occurs.

The present invention proposes that information regarding a reference cell for evaluating whether a measurement report triggering criterion is satisfied (this information is referred to as reference information, and will be described below in detail) is reported by an eNB when a plurality of serving cells are configured in the same frequency band and a measurement report is performed for at least one of the plurality of serving cells. The reference information may indicate the reference cell for determining whether the measurement report triggering criterion is satisfied among the plurality of serving cells of the same frequency band.

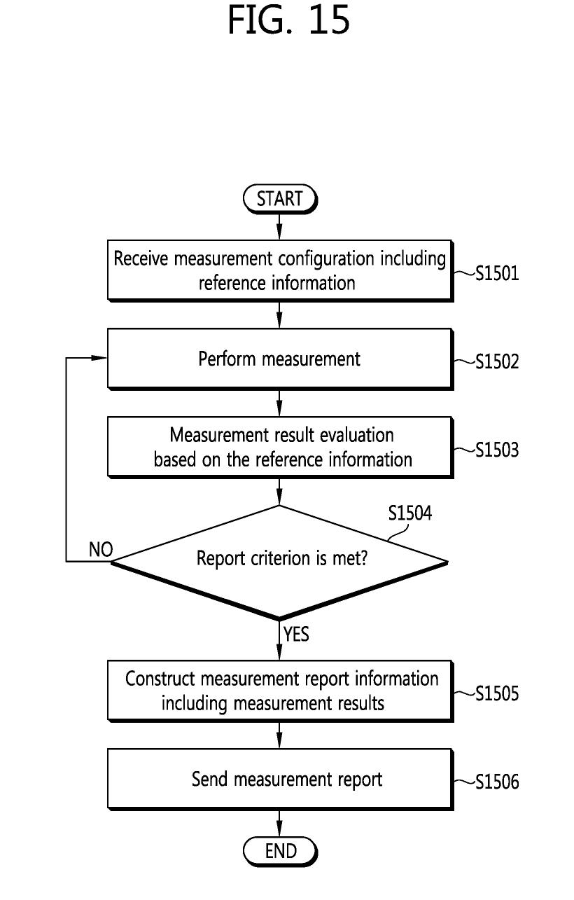

FIG. 15 shows a method of performing a measurement report of a UE according to an embodiment of the present invention.

The UE may receive measurement configuration information from an eNB (or a network) (S1501). As described above with reference to Table 1 above, the measurement configuration information may include measurement object information, reporting configuration information, measurement identity information, quantity configuration information, and measurement gap information. In addition, as described above with reference to FIG. 9 and FIG. 10, the measurement configuration information may include information such as a specific measurement object and/or a specific measurement identity deletion/addition or the like.

In this case, the measurement configuration information may include reference information. The reference information may be included specifically in reporting configuration information among the measurement configuration information.

Table 4 shows an example of the conventional report configuration message.

TABLE 4

| | |
|---|---|
| -- ASN1START | |
| ReportConfigEUTRA ::= | SEQUENCE { |
| triggerType | CHOICE { |
| event | SEQUENCE { |
| eventId | CHOICE { |
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresnoldEUTRA, |
| a5-Threshold2 | ThresholdEUTRA |
| }, | |
| ..., | |
| eventA6-r10 | SEQUENCE { |

| | |
|---|---|
| a6-Offset-r10 | INTEGER (−30..30), |
| a6-ReportOnLeave-r10 | BOOLEAN |
| } | |
| }, | |

| | |
|---|---|
| hysteresis | Hysteresis, |
| timeToTrigger | TimeToTrigger |
| }, | |
| periodical | SEQUENCE { |
| purpose | ENUMERATED { |
| | reportStrongestCells, reportCGI} |
| } | |
| }, | |
| triggerQuantity | ENUMERATED {rsrp, rsrq}, |
| reportQuantity | ENUMERATED {sameAsTriggerQuantity, both}, |
| maxRoportCells | INTEGER (1..maxCellReport), |
| reportInterval | ReportInterval, |
| reportAmount | ENUMERATED {r1, r2, r4, r8, r16, r32, r64, |
| infinity}, | |
| ..., | |

| | | |
|---|---|---|
| [[ si-RequestForHO-r9 | ENUMERATED {setup} | OPTIONAL, -- Cond |
| reportCGI | | |
| ue-RxTxTimeDiffPeriodical-r9 | ENUMERATED {setup} | OPTIONAL -- Need |
| OR | | |
| ]], | | |
| [[ includeLocationInfo-r10 | ENUMERATED {true} | OPTIONAL, -- |
| Need OR | | |
| reportAddNeighMeas-r10 | ENUMERATED {setup} | OPTIONAL -- Need |
| OR | | |
| ]] | | |
| } | | |

| | |
|---|---|
| ThresholdEUTRA ::= | CHOICE{ |
| threshold-RSRP | RSRP-Range, |
| threshold-RSRQ | RSRQ-Range |
| } | |
| -- ASN1STOP | |

In Table 4, a3-Offset/a6-Offset denotes an offset value in the measurement report triggering condition for the event a3/a6.

aN-ThresholdM denotes a threshold used in the measurement report triggering condition for the event aN.

eventId denotes a selection of E-UTRA for the event triggering report condition.

maxReportCells denotes the maximum number of cells (other than a serving cell) included in the measurement report.

reportAmount denotes the number of measurement reports applicable to not only the triggerType periodical but also the triggerType.

reportOnLeave/a6-reportOnLeave indicates whether to start a measurement report process when a leaving condition is satisfied for one cell in the cellsTriggeredList.

reportQuantity denotes an amount to be included in the measurement report.

timeToTrigger denotes a time at which an event must satisfy a specific condition to trigger the measurement report.

Trigger Quantity denotes an amount used to evaluate a condition of triggering an event.

Reference information may be included in the reporting configuration information. The reference information is information used in measurement result evaluation for determining whether the measurement report triggering criterion is satisfied, and may include at least one of the followings.

(1) The reference information may indicate a specific serving cell. For example, the reference information may indicate a cell ID of the specific serving cell. When the specific serving cell is indicated, a measurement of the specific serving cell is used as a serving cell measurement for evaluating an event for a concerned frequency. In this case, the reporting configuration information including the reference information may be configured as follows.

TABLE 6

| | |
|---|---|
| ReportConfigEUTRA ::= | SEQUENCE { |
| triggerType | CHOICE { |
| event | SEQUENCE { |
| eventId | CHOICE { |
| eventA1 | SEQUENCE { |
| a1-Threshold | ThresholdEUTRA |
| serving cell ID | reference information |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |

If the reporting configuration information of Table 5 is given, the UE uses a measurement for the specific serving cell indicted by the reference information when evaluating whether the event A1 satisfies a criterion.

(2) The reference information may indicate any serving cells instead of indicating the specific serving cell. If any serving cells are indicated by the reference information, a measurement result of all serving cells for a concerned frequency band is used as a serving cell measurement for evaluating an event. A measurement report is triggered when any serving cell satisfies the event in the concerned frequency band. In this case, configuration information including the reference information may be configured as follows.

TABLE 6

| | |
|---|---|
| ReportConfigEUTRA ::= | SEQUENCE { |
| triggerType | CHOICE { |
| event | SEQUENCE { |
| eventId | CHOICE { |
| eventA1 | SEQUENCE { |
| a1-Threshold | ThresholdEUTRA |
| Any ServingCell | reference information |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |

If the reporting configuration information of Table 6 is given, the UE uses a measurement for all serving cells of a concerned frequency band when evaluating whether the event A1 satisfies a criterion. In this case, the UE performs the measurement report when any one of the serving cells of the concerned frequency band satisfies a criterion of the event A1.

(3) The reference information may indicate any secondary serving cells. The secondary serving cell is indicated in the case (3) as oppose to the case (2) in which all serving cells are indicated without distinction of a primary serving cell and the secondary serving cell.

Herein, the primary serving cell may be defined as a serving cell which provides the UE with a primary cell in a carrier aggregation, a mobility anchor cell, or an RRC function/signaling. When a macro cell and a small cell are configured in the same UE, the mobility anchor cell may be the macro cell.

The secondary serving cell may be defined as a serving cell which does not provide the UE with a secondary cell in the carrier aggregation, a small cell additionally configured in load balancing in a macro cell coverage, or an RRC function/signalling.

If any secondary serving cells are indicated by the reference information, a measurement result of all secondary serving cells for a concerned frequency band is used as a serving cell measurement for evaluating an event. A measurement report is triggered when any secondary serving cell satisfies the event in the concerned frequency band. In this case, configuration information including the reference information may be configured as follows.

TABLE 7

| | |
|---|---|
| ReportConfigEUTRA ::= | SEQUENCE { |
| triggerType | CHOICE { |
| event | SEQUENCE { |
| eventId | CHOICE { |

| | |
|---|---|
| eventA1 | SEQUENCE { |
| a1-Threshold | ThresholdEUTRA |
| }, | |
| eventA2 | SEQUENCE { |
| a2-Threshold | ThresholdEUTRA |
| Any SecondaryServingCell | reference information |
| }, | |
| eventA3 | SEQUENCE { |
| a3-Offset | INTEGER (−30..30), |
| reportOnLeave | BOOLEAN |

If the reporting configuration information of Table 7 is given, the UE uses a measurement for all secondary serving cells of a concerned frequency band when evaluating whether the event A2 satisfies a criterion. In this case, the UE performs the measurement report when any one of the secondary serving cells of the concerned frequency band satisfies the criterion of the event A2.

Meanwhile, Tables 5 to 7 above show only a part modified in Table 4 showing the conventional report configuration message.

The UE may perform a quality measurement according to the measurement configuration information received as described above (S1502).

Accordingly, the UE may perform a measurement result evaluation procedure for determining whether a quality measurement result value satisfies a quality report criterion (S1503).

As described above in S1501, when it is determined whether a criterion of a specific event is satisfied, the UE may determine which serving cell's measurement result is used, on the basis of reference information. According to the reference information, for example, any one of (1) a specific serving cell, (2) all serving cells, and (3) all secondary serving cells may be indicated for a concerned frequency band. Although a case where the reference cell indicated by the reference information is the specific serving cell, any serving cells, and any secondary serving cells is exemplified in the aforementioned embodiment, the present invention is not necessarily limited thereto. For example, the reference information may indicate a serving cell having a best channel quality (i.e., a best serving cell) and a secondary serving cell having a best channel quality (i.e., a best secondary serving cell).

If the measurement result does not satisfy the report criterion, the measurement is performed again (S1502).

If the measurement result satisfies the report criterion (S1504), the UE constructs measurement report information including the measurement result (S1505), and transmits a measurement report to an eNB (S1506).

Meanwhile, if the reference information is not included in the report configuration message, the UE may use a measurement of the primary serving cell as a serving cell measurement for evaluating an event. Hereinafter, a method of operating the UE when the reporting configuration information including the aforementioned reference information is given will be described for example.

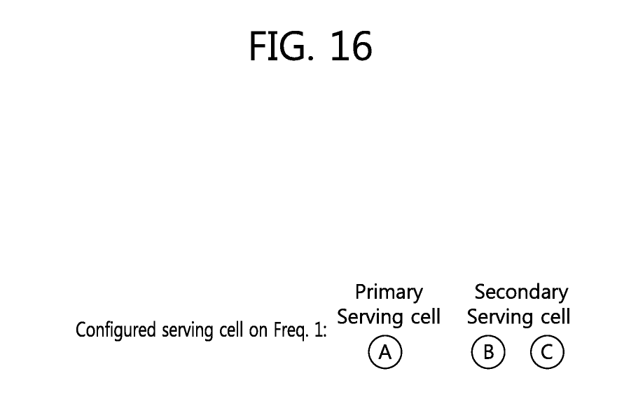

FIG. 16 shows an example in which a plurality of serving cells are configured in a UE in the same frequency band.

Referring to FIG. 16, in a frequency band 1, a serving cell A may be configured in the UE as a primary serving cell, and serving cells B and C may be configured in the UE as a secondary serving cell.

For example, the serving cell A may be a macro cell, and the serving cells B and C may be two adjacent small cells located in a coverage of the serving cell A.

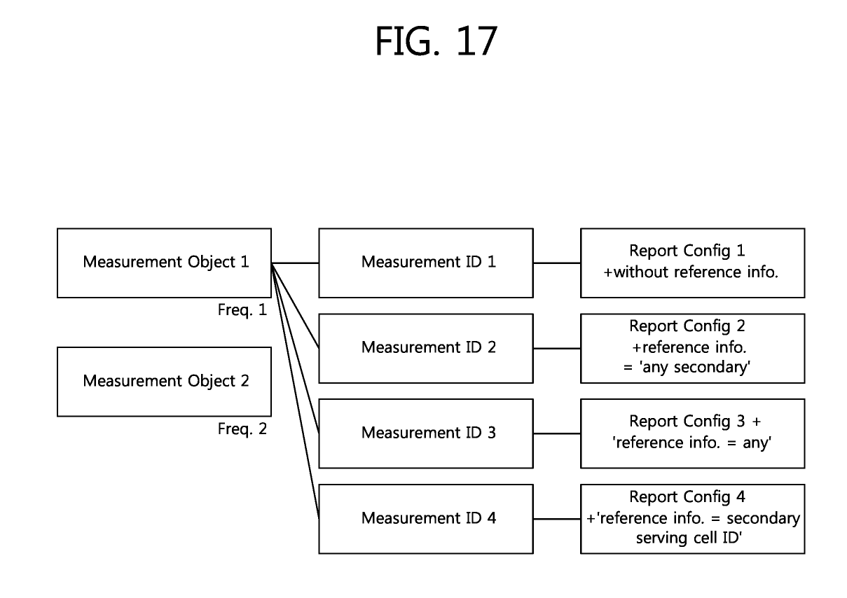

FIG. 17 shows an example of a measurement configuration configured in a UE to which a plurality of serving cells are configured in the same frequency band as shown in FIG. 16 according to the present invention.

Referring to FIG. 17, first, a Measurement ID 1 is linked to a Measurement Object 1 and a Report Config 1. The Report Config 1 may not include reference information. For example, if the Report Config 1 includes an event A3 as a report triggering condition, the UE may use a measurement for a primary serving cell as a serving cell measurement for evaluating the event A3.

Meanwhile, a Measurement ID 2 is linked to the Measurement Object 1 and a Report Config 2. It is assumed that the Report Config 2 may include reference information, and the reference information indicates any secondary serving cells. Further, if the Report Config 2 includes an event A2 as the report triggering condition, the UE may use a measurement for all secondary serving cells as a serving cell measurement for evaluating the event A2.

A Measurement ID 3 is linked to the Measurement Object 1 and a Report Config 3. It is assumed that the Report Config 3 may include reference information, and indicates any serving cells. Further, if the Report Config 3 includes an event A1 as the report triggering condition, the UE may use a measurement for all serving cells as a serving cell measurement for evaluating the event A1.

Further, a Measurement ID 4 is linked to the Measurement ID 1 and a Report Config 4. It is assumed that the Report Config 4 may include reference information, and the reference information indicates a specific serving cell. Further, if the Report Config 4 includes the event A1 as the report triggering condition, the UE may use a measurement for a specific serving cell indicated by the reference information as a serving cell measurement for evaluating the event A1.

Hereinafter, a UE and an eNB for performing the aforementioned measurement report mechanism will be described according to another aspect of the present invention.

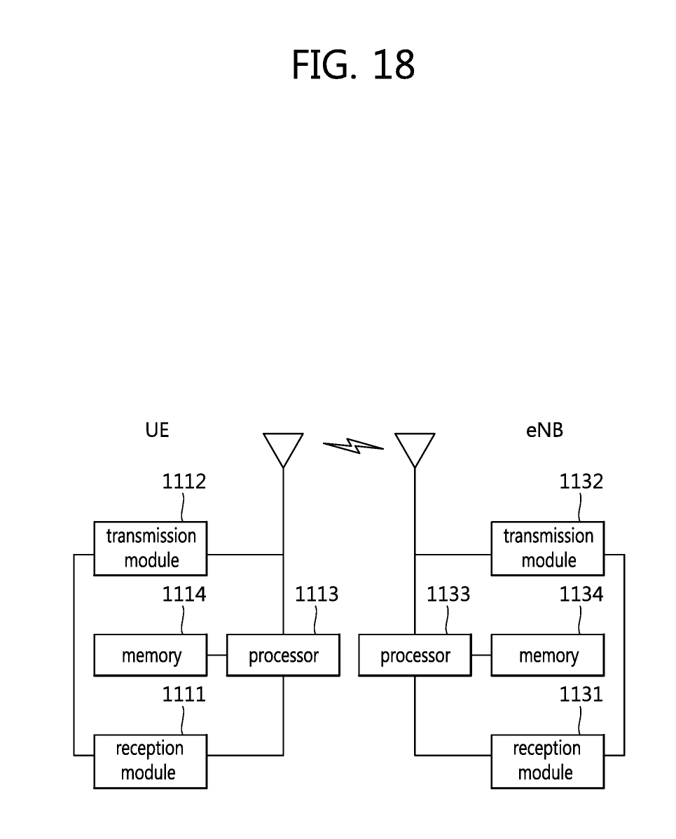

FIG. 18 shows a structure of a wireless communication system including a UE and an eNB according to the present invention.

Referring to FIG. 18, the UE may include a reception module 1111, a transmission module 1112, a processor 1113, and a memory 1114. The reception module 1111 may receive various signals, data, information, or the like from the eNB or the like. The transmission module 1112 may transmit the various signals, data, information, or the like to the eNB or the like. Further, the reception module 1111 may receive the aforementioned measurement configuration information including reference information from a network. The processor 1113 may decide which serving cell is used as a basis of determining whether a measurement report trigger event is satisfied among a plurality of serving cells configured in the same frequency band on the basis of the reference information of the measurement configuration information received through the reception module 1111.

Meanwhile, the eNB may include a reception module 1131, a transmission module 1132, a processor 1133, and a memory 1134. The reception module 1131 may receive various signals, data, information, or the like from the UE or the like. The transmission module 1132 may transmit the various signals, data, information, or the like to the UE or the like.

The processor 1133 transmits measurement configuration information including reference information through the transmission module 1132. A mobility of the UE may be managed through a measurement report message received from the UE by the reception module 1131. In addition thereto, the processor 1133 may perform a function of performing an arithmetic operation of information received by the UE, information to be transmitted to an external element, or the like. The memory 1134 may store the information or the like undergone the arithmetic operation during a specific time, and may be replaced with a constitutional element such as a buffer (not shown) or the like.

The aforementioned embodiments and modifications can be implemented through various means. For example, the embodiments of the present invention can be implemented in hardware, firmware, software, combination of them, etc.

In case of the hardware implementation, the method according to the embodiments of the present invention can be implemented by one or more application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, or the like.

What is claimed is:

1. A method of performing a quality measurement report of a user equipment (UE) in which a plurality of serving cells are configured in the same frequency band, the method comprising:
receiving measurement configuration information;
performing a quality measurement on some or all of the plurality of serving cells according to the measurement configuration information;
determining whether a measurement report criterion is satisfied on the basis of a result of the quality measurement; and
transmitting a report message containing the result of the quality measurement if the measurement report criterion is satisfied,
wherein the measurement configuration information contains reference information, and
wherein the reference information indicates a reference cell for determining whether the measurement report criterion is satisfied.

2. The method of claim 1,
wherein the measurement configuration information contains measurement object information indicating an object for which the UE will perform the measurement and reporting configuration information for reporting the measurement report criterion, and
wherein the reference information is contained in the reporting configuration information.

3. The method of claim 1, wherein the reference information indicates a specific serving cell among the plurality of serving cells as the reference cell.

4. The method of claim 3, wherein the report message is transmitted if the measurement report criterion is satisfied for the specific serving cell.

5. The method of claim 1, wherein the reference information indicates all of the plurality of serving cells as the reference cell.

6. The method of claim 5, wherein the report message is transmitted if even one serving cell among the plurality of serving cells satisfies the measurement report criterion.

7. The method of claim 1, wherein the reference information indicates all secondary serving cells among the plurality of serving cells as the reference cell.

8. The method of claim 7, wherein the report message is transmitted if even one secondary serving cell among the plurality of serving cells satisfies the measurement report criterion.

9. The method of claim 7, wherein the secondary serving cell is a serving cell which does not provide a radio resource control (RRC) function and signaling to the UE.

10. A user equipment (UE) in which a plurality of serving cells are configured in the same frequency band, the UE comprising:
a reception module for receiving measurement configuration information from a network;
a processor for controlling a quality measurement operation according to the measurement configuration information received through the reception module,
wherein the processor is configured to:
perform a quality measurement on some or all of the plurality of serving cells according to the measurement configuration information;
determine whether a measurement report criterion is satisfied on the basis of a result of the quality measurement; and
transmit a report message containing the result of the quality measurement if the measurement report criterion is satisfied,
wherein the measurement configuration information contains reference information, and
wherein the reference information indicates a reference cell for determining whether the measurement report criterion is satisfied.
